(19) United States
(12) Patent Application Publication
(10) Pub. No.: US 2009/0074498 A1
(43) Pub. Date: Mar. 19, 2009

(54) RIBBON CASSETTE STRUCTURE INTEGRATED WITH PAPER FEED TRAY AND PRINTER USING THE RIBBON CASSETTE STRUCTURE INTEGRATED WITH PAPER FEED TRAY

(75) Inventors: Takashi Nakai, Fukushima-ken (JP); Mitsuo Tsushima, Fukushima-ken (JP); Hitoshi Funaki, Fukushima-ken (JP); Susumu Arauchi, Fukushima-ken (JP); Keigo Wakana, Fukushima-ken (JP); Teru Nishiyama, Fukushima-ken (JP); Yasutoshi Inoue, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/212,117

(22) Filed: Sep. 17, 2008

(30) Foreign Application Priority Data
Sep. 18, 2007 (JP) 2007-240952

(51) Int. Cl. B41J 35/28

(52) U.S. Cl. 400/208

(57) ABSTRACT

A ribbon cassette structure integrated with a paper feed tray includes a ribbon cassette that includes a pair of bobbin receiving units and is integrated with a paper feed tray. One of the pair of bobbin receiving units that are connected to each other, and the paper feed tray are pivotally connected to each other so as to be opened or closed between an open state where the one of the pair of bobbin receiving units and the paper feed tray are mostly separated from each other, and a closed state where the one of the pair of bobbin receiving units and the paper feed tray come in contact with each other.

### CROSS REFERENCE TO RELATED APPLICATIONS

The present invention contains subject matter related to and claims priority to Japanese Patent Application JP 2007-240952 filed in the Japanese Patent Office on Sep. 18, 2007, the entire contents of which is incorporated herein by reference.

### BACKGROUND

1. Technical Field

The present invention relates to a ribbon cassette structure integrated with a paper feed tray where a paper feed tray and a pair of ribbon cassettes are integrated with each other and a printer using the ribbon cassette structure integrated with a paper feed tray, and more particularly, to a ribbon cassette structure integrated with a paper feed tray that is made compact and a printer that makes the ribbon cassette structure integrated with a paper feed tray be easily used.

2. Related Art

In the past, various kinds of printers have been used as output units of various devices. The printers are classified into a thermal printer, an inkjet printer, and a diazo printer according to recording methods. Among these printers, a thermal printer includes a thermal head in which a plurality of heater elements is arranged. The thermal printer selectively supplies current to a specific heater element according to recording information to make the specific heater element generate heat, and colors thermal recording paper or partially transfers ink of an ink ribbon or an ink sheet onto a sheet, thereby performing recording.

Among the above-mentioned thermal printers, a thermal printer using an ink ribbon includes a ribbon cassette that receives the ink ribbon. Meanwhile, a printer, which uses a cut sheet as a sheet, generally uses a paper feed tray in which cut sheets are stacked and stored.

Further, in the past, there has been known a ribbon cassette structure integrated with a paper feed tray where a ribbon cassette and a paper feed tray are integrated with each other in consideration of a fact that the handling of a ribbon cassette and a paper feed tray is complicated if the ribbon cassette and the paper feed tray are composed of separate bodies (for example, as shown Japanese Unexamined Patent Application Publication No. 2005-335292).

However, in the ribbon cassette structure integrated with a paper feed tray disclosed in Japanese Unexamined Patent Application Publication No. 2005-335292, a paper feed tray and a ribbon cassette have been integrated with each other not to move relative to each other. Accordingly, the thermal head has a cantilever structure where one end of a thermal head cannot be supported and only the other end thereof is supported. For this reason, there is a problem in terms of stiffness or accuracy. Therefore, there has been a demand for a structure that meets the performance in terms of stiffness or accuracy.

Further, in order not to make the thermal head have a cantilever structure, the paper feed tray and the ribbon cassette are connected to each other in a V shape, and a space in which the thermal head can be positioned is required between the paper feed tray and the ribbon cassette. Furthermore, since the volume of the ribbon cassette structure is large during conveyance on a distribution path, an unnecessary space has been required.

These and other drawbacks exist.

### SUMMARY

An advantage of some aspects of embodiments of the invention is to provide a ribbon cassette structure integrated with a paper feed tray that is made compact during conveyance on a distribution path and has a form suitable for use when being used in a printer.

Further, another advantage of some aspects of embodiments of the invention is to provide a printer that is suitable for using the ribbon cassette structure integrated with a paper feed tray.

According to an aspect of embodiments of the invention, in a ribbon cassette structure integrated with a paper feed tray, one of a pair of bobbin receiving units that are connected to each other, and the paper feed tray are pivotally connected to each other so as to be opened or closed between an open state where the one of the pair of bobbin receiving units and the paper feed tray are mostly separated from each other, and a closed state where the one of the pair of bobbin receiving units and the paper feed tray come in contact with each other. Accordingly, if this structure is employed, the ribbon cassette structure comes to a closed state when being not used. As a result, it is possible to make the ribbon cassette structure compact during conveyance on a distribution path.

In the ribbon cassette structure integrated with a paper feed tray, an end of one bobbin receiving unit may be pivotally connected to an end of the paper feed tray. Accordingly, if this structure is employed, it is possible to make the ribbon cassette structure more compact in the closed state.

In addition, in the ribbon cassette structure integrated with a paper feed tray, when one bobbin receiving unit and the paper feed tray are in the closed state, a locked member formed in one of the one bobbin receiving unit and the paper feed tray may be fitted to a locking member formed in the other thereof, so that the closed state is maintained in a free state. Accordingly, if this structure is employed, it is possible to prevent the ribbon cassette structure from being carelessly opened in the closed state.

Further, in the ribbon cassette structure integrated with a paper feed tray, grooves may be formed at a border of a connection portion between the one bobbin receiving unit and the paper feed tray, which are in the closed state, so as to face each other. Accordingly, if this structure is employed, the groove of each of the bobbin receiving unit and the paper feed tray is fitted to the tip of the protrusion protruding from the printer. Therefore, it is possible to make one bobbin receiving unit and the paper feed tray, which are in the closed state, come to the open state.

According to another aspect of embodiments of the invention, a printer includes a printer body in which a ribbon cassette structure integrated with a paper feed tray is mounted. In the ribbon cassette structure integrated with a paper feed tray, grooves are formed at a border of a connection portion between one bobbin receiving unit and the paper feed tray, which are in the closed state, so as to face each other. An opening and a protrusion are formed at one side wall of the printer body. A pair of bobbin receiving units and the paper feed tray are inserted into the opening in the open state. The protrusion has a pointed end to be fitted into the grooves of the one bobbin receiving unit and the paper feed tray body that are in the closed state that and separates the locked member from the locking member to make the one bobbin receiving unit and the paper feed tray come to the open state. If this structure is employed, the pointed end of the protrusion is fitted to each of the grooves of the ribbon cassette structure, so that the ribbon cassette structure is pressed and moved toward the protrusion. As a result, the locked member is separated from the locking member, so that it is possible to make the one bobbin receiving unit and the paper feed tray come to the open state.

In the printer, the protrusion may be curved in an arc shape centering on a center of rotation of the bobbin receiving unit or the paper feed tray in a direction orthogonal to a direction where the ribbon cassette structure is mounted. Therefore, the protrusion can continue being fitted to the grooves of the bobbin receiving unit and the paper feed tray in the open state.

In the printer, the protrusion may be formed by outsert molding together with a resin material in another printer body. If this structure is employed, a separate process for forming a protrusion does not need to be performed.

According to an aspect of embodiments of the invention, one bobbin receiving unit and a paper feed tray are maintained in a closed state, so that the ribbon cassette structure integrated with a paper feed tray can be made compact during conveyance on a distribution path and have a form suitable for use by making one bobbin receiving unit and a paper feed tray come to an open state when being used in a printer.

That is, for example, in the ribbon cassette structure integrated with a paper feed tray according to an aspect of embodiments of the invention, one of the pair of bobbin receiving units that are connected to each other, and the paper feed tray are pivotally connected to each other so as to be opened or closed between an open state where the one of the pair of bobbin receiving units and the paper feed tray are mostly separated from each other, and a closed state where the one of the pair of bobbin receiving units and the paper feed tray come in contact with each other. Therefore, the ribbon cassette structure comes to a closed state when not being used. As a result, it is possible to make the ribbon cassette structure compact during conveyance on a distribution path, and to reduce cost required for conveyance.

Further, if an end of one bobbin receiving unit is pivotally connected to an end of the paper feed tray, it is possible to make the ribbon cassette structure more compact in the closed state and to further reduce cost required for conveyance.

Furthermore, if a locked member formed in one of the one bobbin receiving unit and the paper feed tray is fitted to a locking member formed in the other thereof so that the closed state is maintained in a free state. When one bobbin receiving unit and the paper feed tray are in the closed state, it is possible to prevent the ribbon cassette structure from being carelessly opened in the closed state and to stably handle the ribbon cassette structure. In addition, if grooves are formed at a border of a connection portion between the one bobbin receiving unit and the paper feed tray, which are in the closed state, so as to face each other, the groove of each of the bobbin receiving unit and the paper feed tray are fitted to the tip of the protrusion protruding from the printer. Accordingly, it is possible to make one bobbin receiving unit and the paper feed tray, which are in the closed state, come to the open state. Therefore, the ribbon cassette structure does not need to be opened purposely, and can be opened when being mounted in a printer.

Meanwhile, in a printer according to another embodiment of the invention, the ribbon cassette structure integrated with a paper feed tray according to the embodiment of the invention can be used well.

That is, an opening and a protrusion are formed at one sidewall of theprinterbody. The pair of bobbin receiving units and the paper feed tray of the ribbon cassette structure integrated with a paper feed tray are inserted into the opening in the open state. The protrusion has a pointed end to be fitted into each of the grooves of the one bobbin receiving unit and the paper feed tray body that are in the closed state, and separates the locked member from the locking member to make the one bobbin receiving unit and the paper feed tray come to the open state. Accordingly, the pointed end of the protrusion is fitted to each of the grooves of the ribbon cassette structure, so that the ribbon cassette structure is pressed and moved toward the protrusion. Therefore, the locked member is separated from the locking member, so that it is possible to make the one bobbin receiving unit and the paper feed tray come to the open state. For this reason, the ribbon cassette structure integrated with a paper feed tray does not need to be opened purposely, and can be opened when being mounted in a printer.

Further, since the protrusion is curved in an arc shape centering on a center of rotation of the bobbin receiving unit or the paper feed tray in a direction orthogonal to a direction where the ribbon cassette structure is mounted, the protrusion can continue being fitted to the grooves of the bobbin receiving unit and the paper feed tray in the open state, and the ribbon cassette structure can be continuously and stably opened by the protrusion.

In addition, if the protrusion is formed by outsert molding together with a resin material in another printer body, a separate process for forming a protrusion does not need to be performed. Therefore, it is possible to manufacture the protrusion at low cost.

### BRIEF DESCRIPTION OF THE DRAWINGS

FIG. 1 is a perspective view of a ribbon cassette structure integrated with a paper feed tray according to an embodiment of the invention, showing the ribbon cassette and paper feed tray in a closed state.

FIG. 2 is a perspective view showing that the ribbon cassette and the paper feed tray shown in FIG. 1 are in an open state.

FIG. 3 is an exploded view of FIG. 1.

FIG. 4A is a side view showing the open state of main opening and closing parts of FIG. 1.

FIG. 4B is a view showing the closed state of FIG. 4A.

FIG. 5 is a perspective view of another example of an opening and closing structure of the paper feed tray and the ribbon cassette of FIG. 1.

FIG. 6 is a perspective view of FIG. 5 as seen in another direction.

FIG. 7A is a longitudinal cross-sectional view showing a lock mechanism of the ribbon cassette and the paper feed tray of FIG. 1.

FIG. 7B is an enlarged view of certain components of FIG. 7A.

FIG. 8A is a longitudinal cross-sectional view showing the ribbon cassette and the paper feed tray of FIG. 1 that are in an open state.

FIG. 8B is a longitudinal cross-sectional view of the ribbon cassette and the paper feed tray of FIG. 8A that are in a closed state.

FIG. 9 is a perspective view of a printer according to another embodiment of the invention.

FIG. 10A is a front view showing protrusions formed on a side wall of FIG. 9.

FIG. 10B is a perspective view of FIG. 10A as seen from below.

FIG. 10C is a side view of the protrusions.

### DESCRIPTION OF EXEMPLARY EMBODIMENTS

Exemplary embodiments are discussed in detail below. While specific exemplary embodiments are discussed, it should be understood that this is done for illustration purposes only. A person skilled in the relevant art will recognize that other components and configurations can be used without departing from the spirit and scope of the claimed inventions.

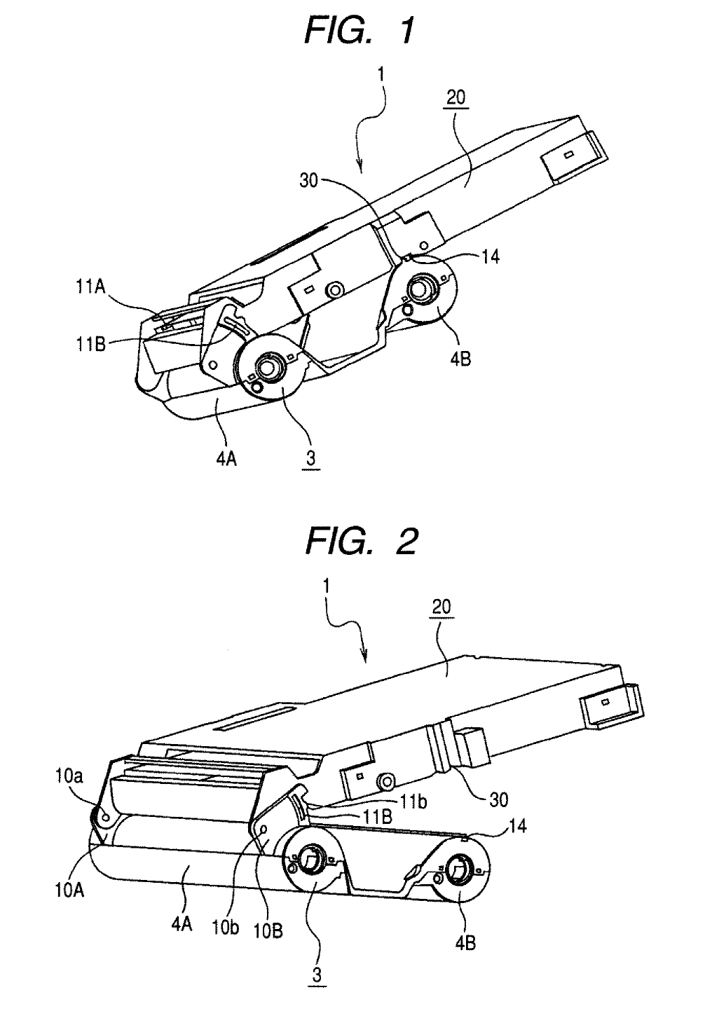

FIGS. 1 to 3 are views showing a ribbon cassette structure integrated with a paper feed tray according to an exemplary embodiment of the invention, and the ribbon cassette structure 1 integrated with a paper feed tray according to the embodiment includes a ribbon cassette 3 and a paper feed tray 20 that are integrated with each other. The ribbon cassette includes a pair of cylindrical bobbin receiving units 4A and 4B.

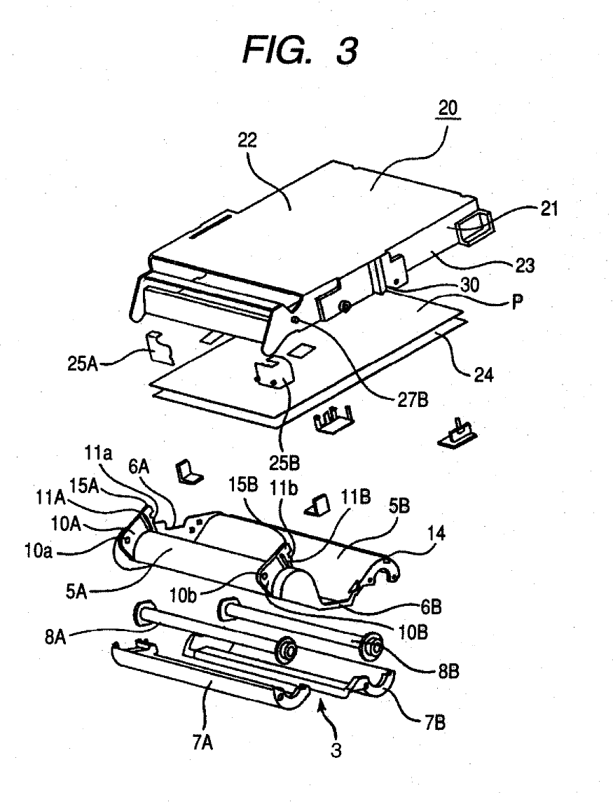

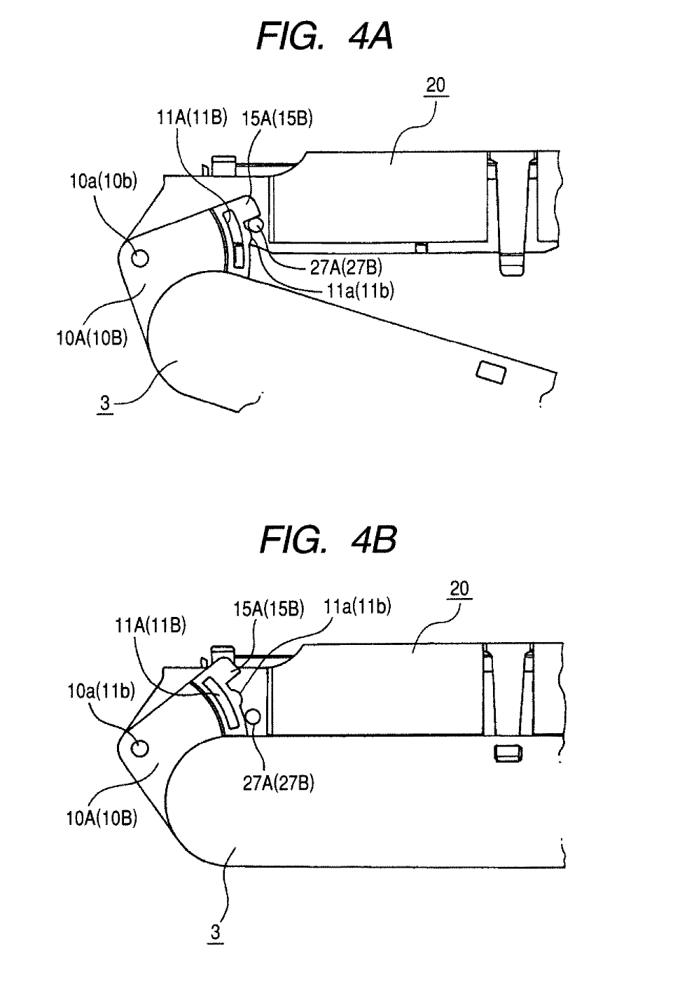

Referring now to FIG. 3, showing an exploded view of FIG. 1, the ribbon cassette 3 includes a plate 6A that may be integrated with upper halves 5A and 5B of both bobbin receiving units 4A and 4B at both ends thereof, and lower halves 7A and 7B that may be connected to each other by an arm 6B bend in a deep-dish shaped cross-section and detachably fitted to the upper halves 5A and 5B, respectively. Bobbins 8A and 8B in which ink ribbons (not shown) may be mounted may be rotatably received in the bobbin receiving units 4A and 4B, respectively.

The middle portions of the ink ribbons (not shown), which may be supported by the bobbins 8A and 8B of both the bobbin receiving units 4A and 4B from both ends thereof, may be exposed to the outside of the bobbin receiving units 4A and 4B. Accordingly, when being mounted in a printer to be described below, the ink ribbons may be brought into press contact with a thermal head of the printer.

The paper feed tray 20 may include a box-shaped paper feed tray body 21 in which cut sheets P (for convenience sake, only one cut sheet is shown) may be stacked and stored, and the paper feed tray body 21 may be formed of a rectangular bottom wall 22 and side walls 23 that may stand at four edges of the bottom wall 22. Further, a sheet protecting plate 24, which may protect the cut sheets P stored in the paper feed tray body 21, may be mounted on the paper feed tray body 21. In addition, the paper feed tray body 21 may be provided with two separation claws 25A and 25B that may supply the cut sheets P one by one.

As shown in FIG. 2, a pair of protrusions 10A and 10B may be formed on the upper surface of one bobbin receiving unit 4A of the ribbon cassette 3 so as to be spaced apart from each other by a distance in a horizontal direction, and support shafts 10a and 10b may be provided to protrude from one sides of the protrusions 10A and 10E so as to have the same axis. Meanwhile, protruding portions 11a and 11b, which protrude outward from the protrusions 10A and 10B, are formed on the outer thin portions of the protrusions 10A and 10B, where arc grooves 11A and 11B centering on the support shafts 10a and 10b may be formed, outside the arc grooves 11A and 11B. Stoppers 15A and 15B, which may further protrude as compared to the protruding portions 11a and 11b, may be formed at the end portions of the protrusions 10A and 10B near the arc grooves 11A and 11B, respectively.

The paper feed tray body 21 may be pivoted on the support shafts 10a and 10b, so that the ribbon cassette 3 and the paper feed tray 20 maybe pivotally connected to each other so as to be opened or closed.

Further, protrusions 27A and 27B may protrude from the side surfaces of the paper feed tray body 21, respectively. As the opening/closing operations of the ribbon cassette 3 and the paper feed tray 20 are performed, the protrusions 27A and 27B may be brought into sliding contact with the protruding portions 11a and 11b and may run over the protruding portions 11a and 11b, respectively, while the thin portions having the protruding portions 11a and 11b are elastically pressed and moved in directions of the arc grooves 11A and 11B. In this way, the protrusions 27A and 27B may run over the protruding portions 11a and 11b, respectively, so that a click feeling may be generated during the opening/closing operations.

Furthermore, the paper feed tray 20 may not be opened or closed about the support shafts 10a and 10b. That is, instead of the support shafts 10a and 10b, one shaft may be inserted into the ribbon cassette 3 and the paper feed tray 20, and the ribbon cassette 3 and paper feed tray 20 may be opened or closed about the shaft.

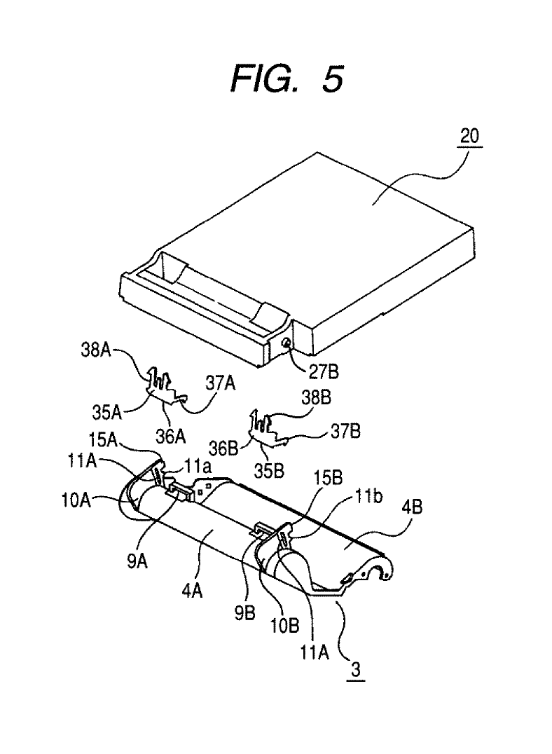

In addition, as shown in FIG. 5, the ribbon cassette 3 and the paper feed tray 20 may be pivotally connected to each other by a pair of hinges 35A and 35B, which may be made of a resin, so as to be open or closed. That is, the hinges 35A and 35B may be formed to be flexible about flexible lines 36A and 36B of the middle portions thereof, respectively, which extend parallel to the axis of the bobbin receiving unit 4A.

Further, a pair of hinge receiving parts 9A and 9B may be formed on the upper surface of the upper half 5A of the bobbin receiving unit 4A, which may be positioned at the end of the ribbon cassette structure 1 integrated with a paper feed tray, so as to be spaced apart from each other by a distance in the horizontal direction. Lower halves 37A and 37B of the hinges 35A and 35B, which may be formed below the flexible lines 36A and 36B, may be received in and fitted to the hinge receiving parts 9A and 9B, respectively.

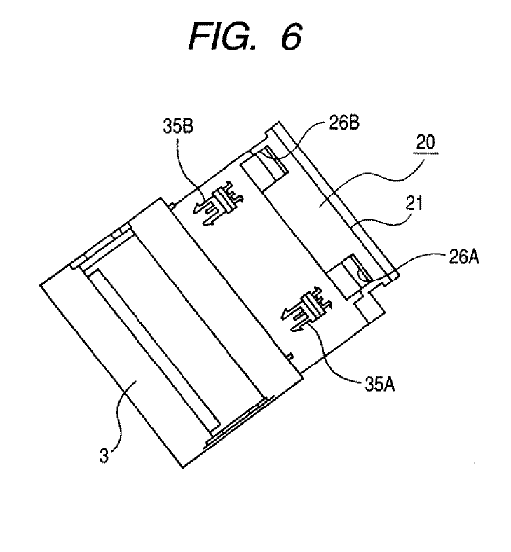

Meanwhile, as shown in FIG. 6, a pair of hinge receiving openings 26A and 26B may be formed at the end of the paper feed tray body 21 of the paper feed tray 20 so as to be spaced apart from each other by a distance in the horizontal direction, and upper halves 38A and 38B of the hinges 35A and 35B, which may be formed above the flexible lines 36A and 36B, may be received in and fitted to the hinge receiving openings 26A and 26B, respectively.

Accordingly, the ribbon cassette 3 and the paper feed tray 20 may be opened or closed about the flexible lines 36A and 36B of the pair of hinges 35A and 35B, between the ends thereof.

The above-mentioned protrusions 10A and 10B may protrude from the ribbon cassette 3. The arc grooves 11A and 11B the protruding portions 11a and 11b, and the stoppers 15A and 15B may be formed in the protrusions 10A and 10B, respectively. Meanwhile, the protrusions 27A and 27B (only one protrusion is shown) may protrude from the side surfaces of the paper feed tray body 21, respectively. Accordingly, like in the above-mentioned embodiment, a click feeling may be obtained, and an angle of an open state may be regulated.

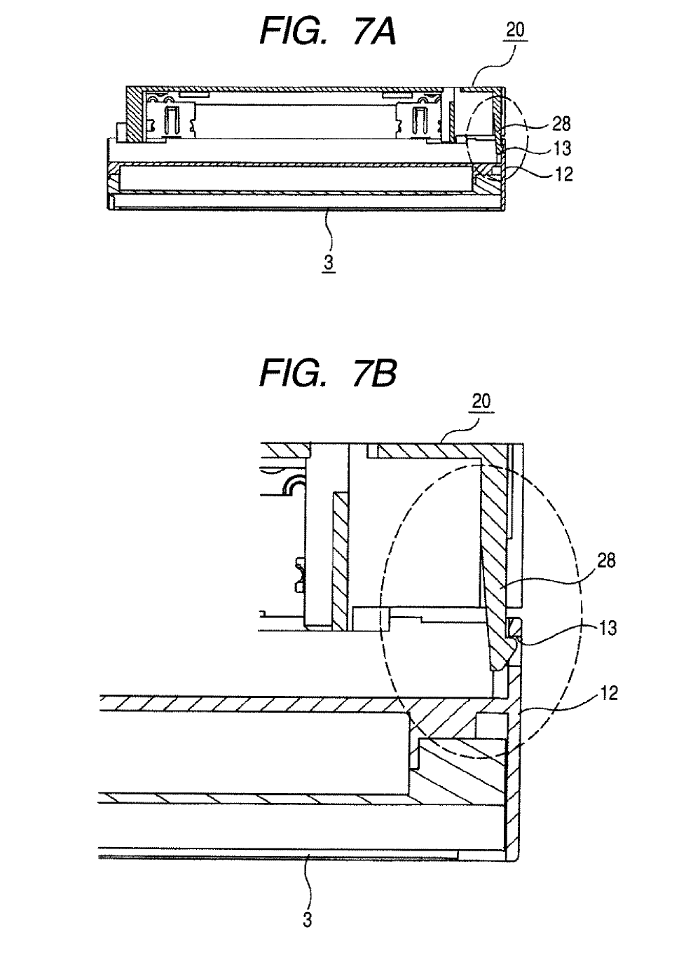

In addition, the ribbon cassette 3 and the paper feed tray 20 may include a lock mechanism for maintaining a closed state. That is, as shown in FIG. 7, a locking member 12 having an opening 13 may be provided at one side portion of one bobbin receiving unit 4A of the ribbon cassette 3. Meanwhile, a hook-shaped locked member 28, which may have flexibility and may be fitted to the opening 13 when the ribbon cassette 3 and the paper feed tray 20 may be in the closed state, may be provided to protrude from one side portion of the paper feed tray body 21.

When the ribbon cassette 3 and the paper feed tray 20 may be in the closed state, the locked member 28 may be fitted to the opening 13 of the locking member 12 so that the closed state may be maintained.

When a force of a set value or more is applied to make the ribbon cassette 3 and the paper feed tray 20 be in the open state, the fit between the locking member 12 and the locked member 28 my be released.

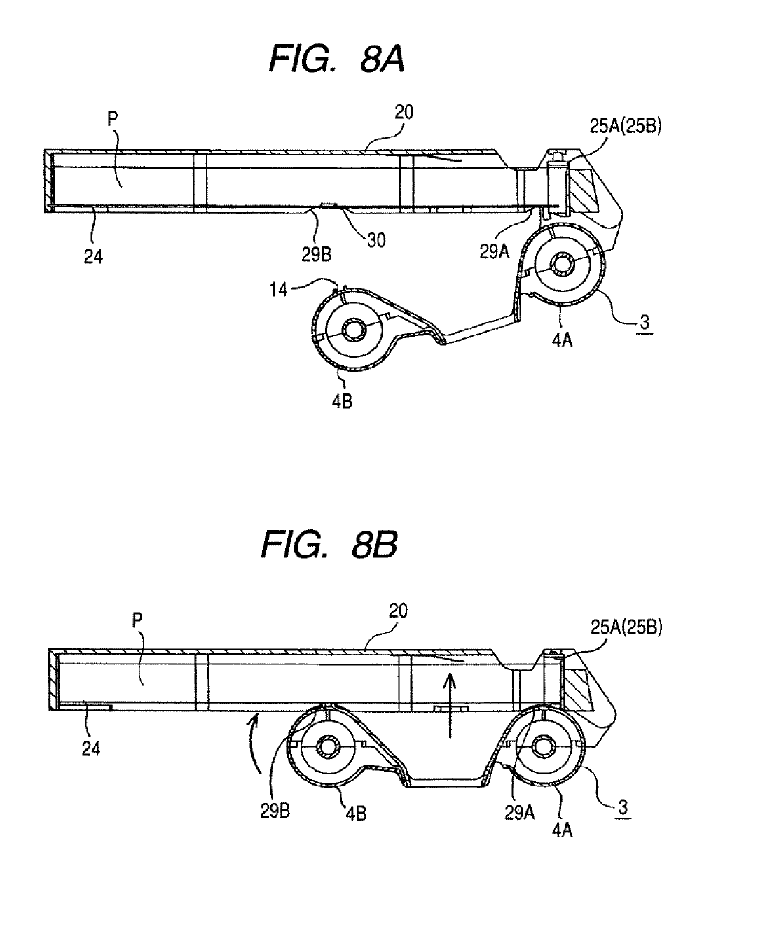

As shown in FIG. 8, recesses 29A and 29B may be formed on the lower surface of the paper feed tray body 21, which may face the upper portions of the bobbin receiving units 4A and 4B of the ribbon cassette 3 in the closed state. Further, the upper portions of the bobbin receiving units 4A and 4B may be fitted to the recesses 29A and 29B in the closed state, respectively, and the upper portions of the bobbin receiving units 4A and 4B may push up the sheet protecting plate 24. As a result, the sheets P, the sheet protecting plate 24, and the separation claws 25A and 25B of the paper feed tray body 21 may be moved upward, so that the dimension of the paper feed tray 20 in a height direction can be decreased by the depth of each of the recesses 29A and 29B. Therefore, the dimension of the paper feed tray in the height direction may be further decreased when the ribbon cassette 3 and the paper feed tray 20 are in the closed state, so that it maybe possible to reduce a space during conveyance.

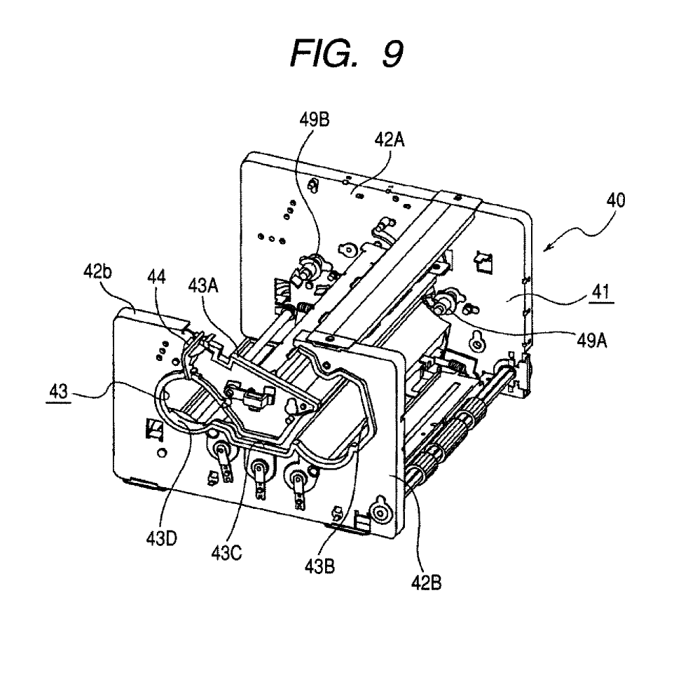

A printer according to an embodiment in which the ribbon cassette structure 1 integrated with a paper feed tray is mounted is shown in FIG. 9,

A printer body 41 of the printer 40 includes a pair of side walls 42A and 42B that stand so as to be spaced apart from each other by a distance, and components of the printer 40 are disposed between the pair of side walls 42A and 42B.

An opening 43, which maybe used to detachably insert the ribbon cassette structure 1 integrated with a paper feed tray into the printer 40, may be formed at one side wall 42B. The opening 43 may be formed to have the shape that allows the ribbon cassette 3 and the paper feed tray 20 of the ribbon cassette structure 1 integrated with a paper feed tray to be inserted into the opening in the open state.

That is, the opening 43 may include a first opening 43A into which a part of the paper feed tray 20 formed to extend obliquely downward from an upper border 42b of the side wall 42B of the printer body 41 may be inserted. A part of an end of the paper feed tray 20 connected to the ribbon cassette 3 may be inserted into the first opening 43A, and a free portion of the paper feed tray 20 may be positioned above the upper border 42b of the side wall 42B.

Further, the bobbin receiving unit 4A, which may be connected to the paper feed tray body 21, of the ribbon cassette 3 of the ribbon cassette structure 1 integrated with a paper feed tray may be inserted into a second opening 43B that may communicate with the first opening 43A.

Furthermore, the arm 6B, which may be bent in a deep-dish shaped cross-section and may connect the bobbin receiving unit 4A with the bobbin receiving unit 42, of the ribbon cassette 3 of the ribbon cassette structure 1 integrated with a paper feed tray may be inserted into a third opening 43C that communicates with the second opening 43B.

In addition, the bobbin receiving unit 4B, which may be connected to the arm 6B, of the ribbon cassette 3 of the ribbon cassette structure 1 integrated with a paper feed tray may be inserted into a fourth opening 43D that communicates with the third opening 43C.

As described above, the opening 43 may be formed in a bent shape, which may be formed by the first to fourth openings 43A to 43D, as a whole so that the ribbon cassette structure 1 integrated with a paper feed tray of which the ribbon cassette 3 and the paper feed tray 20 are in the open state may be inserted into the opening.

Meanwhile, as shown in FIG. 1, U-shaped grooves 14 and 30 facing each other may be formed at a border of a connection portion between the upper half 5B of the bobbin receiving unit 4B and the paper feed tray body 21 of the paper feed tray 20 when the upper half 5B of one bobbin receiving unit 4B of the ribbon cassette 3, which may be formed at the forehead and inserted into the opening 43 formed at the side wall 42B of the printer 40 and the paper feed tray body 21 of the paper feed tray 20 of the ribbon cassette structure 1 integrated with a paper feed tray may be in the closed state.

Returning to FIG. 9, a protrusion 44 having a pointed end 45 to be fitted into the grooves 14 and 30 of the bobbin receiving unit 4B and the paper feed tray body 21, which may be in the closed state as shown in FIG. 1, may be provided to protrude from the outer surface of the side wall 42B of the printer 40 by outsert molding together with other parts protruding from the side wall 42B.

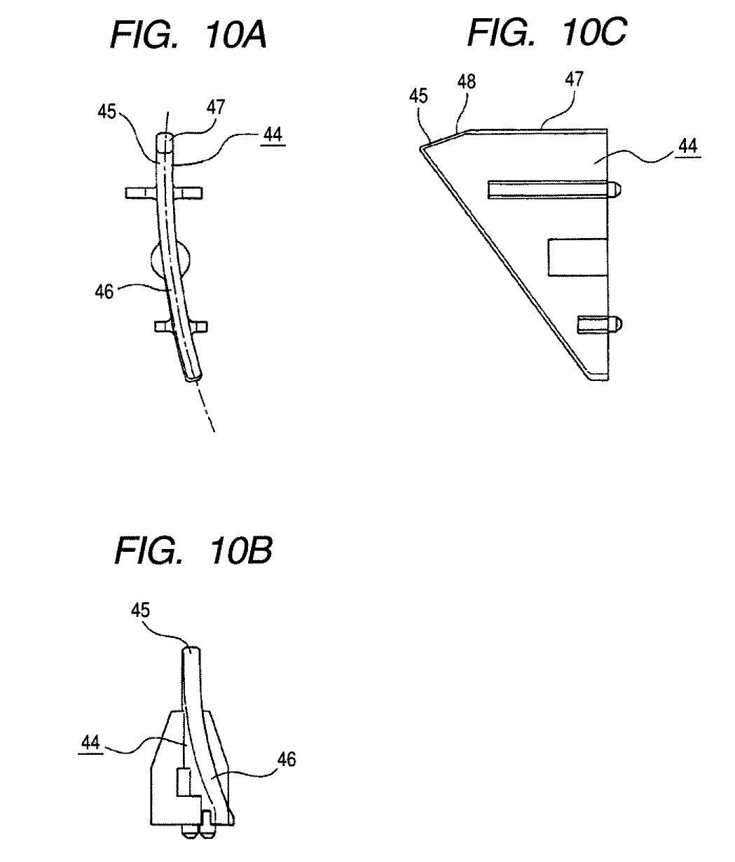

As shown in FIG. 10, the protrusion 44 may have a substantially right-angled triangular shape in side view, and a slope 46 of the protrusion 44 maybe formed to protrude upward. The pointed end 45 may be formed by crossing a gentle slope 48, which may have a gentle angle formed by inclining downward the tip of an upper surface 47 of the protrusion 44, and the slope 46. In this case, the slope 46 may have a dimension larger than the gentle slope 48. Accordingly, when the bobbin receiving unit 4B and the paper feed tray body 21, which may be in the closed state, are brought into press contact with the protrusion 44 and are in the open state, the bobbin receiving unit 4B brought into sliding contact with the slope 46 is mainly opened. For this reason, the protrusion 44 may be formed to be curved in an arc shape centering on the center of the support shafts 10a and 10b, which may be a center of rotation when the bobbin receiving unit 42 is opened in a vertical direction orthogonal to a direction where the ribbon cassette structure 1 integrated with a paper feed tray is mounted in the printer 40.

Meanwhile, driving units 49A and 49B, which may be fitted to the bobbins 8A and 8B received in the bobbin receiving units 4A and 4B of the ribbon cassette 3 of the mounted ribbon cassette structure 1 integrated with a paper feed tray, may be provided to protrude from the inner surface of the other side wall 42A of the printer 40.

The operation of the embodiment having the above-mentioned structure will be described below.

When the ribbon cassette structure I integrated with a paper feed tray is not mounted in the printer 40, it may be possible to reduce a space if the ribbon cassette 3 and the paper feed tray 20 are in the closed state. When the ribbon cassette 3 and the paper feed tray 20 are in the closed state, the paper feed tray 20 and the bobbin receiving unit 4B of the ribbon cassette 3 may be positioned to substantially come in contact with each other,

Further, the locked member 28 of the paper feed tray 20 may be engaged with the locking member 12 of the ribbon cassette 3 in the closed state, so that the closed state may be maintained.

In order to mount the ribbon cassette structure 1 integrated with a paper feed tray, which is in the closed state, in the printer 40, the U-shaped grooves 14 and 30 formed at the border of the connection portion between the upper half 5B of the bobbin receiving unit 4B and the paper feed tray body 21 of the paper feed tray 20 may knock against the pointed end 45 of the protrusion 44 that may be provided to protrude from the outer surface of one side wall 42B of the printer 40, and may press the ribbon cassette structure 1 integrated with a paper feed tray against the protrusion 44. Then, the bobbin receiving unit 4B may be rotated about the support shafts 10a and 10b along the slope 46 of the protrusion 44, and may be separated from the paper feed tray 20. Finally, the ribbon cassette 3 and the paper feed tray 20 may come to the open state.

Meanwhile, in this case, the fit between the locking member 12 of the ribbon cassette 3 and the locked member 28 of the paper feed tray 20 may be released by pressing the ribbon cassette structure 1 integrated with a paper feed tray against the protrusion 44 so that the ribbon cassette 3 and the paper feed tray 20 may be in the open state.

Since the ribbon cassette 3 and the paper feed tray 20 come to in the open state as described above, the ribbon cassette structure 1 integrated with a paper feed tray may be mounted in the printer 40 through the opening 43 of the side wall 42B of the printer 40.

According to the embodiment, the grooves 14 and 30 of the ribbon cassette 3 and the paper feed tray 20 of the ribbon cassette structure 1 integrated with a paper feed tray, which are in the closed state, may be pressed against the protrusion 44, so that the ribbon cassette 3 and the paper feed tray 20 may be opened. As a result, the printer 40 can become available.

Meanwhile, the invention is not limited to the above-mentioned embodiment, and may have various modifications if necessary.

The present disclosure is not intended to be limited by the specific embodiments described herein.

It should be understood by those skilled in the art that various modifications, combinations, sub-combinations and alterations may occur depending on design requirements and other factors insofar as they are within the scope of the appended claims and the equivalents thereof.

1. A ribbon cassette structure integrated with a paper feed tray, the ribbon cassette structure comprising:
a ribbon cassette that includes a pair of bobbin receiving units and is integrated with a paper feed tray,
wherein one of the pair of bobbin receiving units and the paper feed tray are pivotally connected to each other so as to be opened or closed between an open state wherein the one of the pair of bobbin receiving units and the paper feed tray are mostly separated from each other, and a closed state wherein the one of the pair of bobbin receiving units and the paper feed tray come in contact with each other.

2. The ribbon cassette structure according to claim 1,
wherein an end of the one of the pair of bobbin receiving units is pivotally connected to an end of the paper feed tray.

3. The ribbon cassette structure according to claim 1,
wherein when the one of the pair of bobbin receiving units and the paper feed tray are in the closed state, a locked member formed in one of the one bobbin receiving unit and the paper feed tray is fitted to a locking member formed in the other thereof, so that the closed state is maintained in a free state.

4. The ribbon cassette structure according to claim 1, further comprising:
grooves formed at a border of a connection portion between the one bobbin receiving unit and the paper feed tray, which are in the closed state, so as to face each other.

5. A printer comprising:
a printer body in which the ribbon cassette structure integrated with a paper feed tray according to claim 4 is mounted,
wherein an opening and a protrusion are formed at one side wall of the printer body,
the pair of bobbin receiving units and the paper feed tray are inserted into the opening in the open state, and
the protrusion has a pointed end to be fitted into each of the grooves of the one bobbin receiving unit and the paper feed tray body that are in the closed state, and separates the locked member from the locking member to make the one bobbin receiving unit and the paper feed tray come to the open state.

6. The printer according to claim 5,
wherein the protrusion is curved in an arc shape centering on a center of rotation of the bobbin receiving unit or the paper feed tray in a direction orthogonal to a direction where the ribbon cassette structure integrated with a paper feed tray is mounted, so as to continue being fitted to the grooves of the bobbin receiving unit and the paper feed tray in the open state.

7. The printer according to claim 5,
wherein the protrusion is formed by outsert molding together with a resin material in another printer body.
